(19) United States
(12) Patent Application Publication
(10) Pub. No.: US 2016/0057515 A1
(43) Pub. Date: Feb. 25, 2016

(54) SIGNAL ROUTING

(71) Applicant: BRITISH TELECOMMUNICATIONS public limited company, London (GB)

(72) Inventor: Andrew LORD, LONDON (GB)

(21) Appl. No.: 14/780,959

(22) PCT Filed: Mar. 12, 2014
(86) PCT No.: PCT/GB2014/000090

§ 371 Date: Sep. 28, 2015

(30) Foreign Application Priority Data
Mar. 28, 2013 (GB) 1305818.5

(51) Int. Cl. H04Q 11/00

(52) U.S. Cl. CPC H04Q 11/0005; H04Q 11/0062; H04Q 2011/0015

(57) ABSTRACT

An upgradable optical route for tis use in an optical switching network is disclosed. In an initial configuration, the optical router contains wavelength selective switches configured to switch optical signals having WDM wavelengths positioned in a grid having exactly 100 GHz (about 0.8 nm) spacing in optical frequency, aka fixed grid. The interface ports and optical backplane within the optical switch contain an optical splitter and optical coupler and additionally space for a second selective switch. At a later point in time, a second wavelength selective switch can be added to provide additional capabilities such as switching wavelengths positioned in at flexible grid.

### RELATED APPLICATIONS

The present application is a National Phase entry of PCT Application No. PCT/GB2014/000090, filed Mar. 12, 2014, which claims priority to GB 1305818.5, filed Mar. 28, 2013, the contents of which are incorporated herein by reference in their entireties.

### TECHNICAL FIELD

Embodiments relate to optical data transmission and in particular to an upgradable optical routing apparatus for switching optical signals using two optical carrier transmission schemes.

### BACKGROUND

In optical data transmission, a signal to be transmitted is sent as a sequence of light pulses over an optical fiber to a photo detector which converts the optical signal into an electronic one for subsequent processing. The most straightforward method of data transmission is to provide a different optical fiber per transmission. However, the use of a different fiber per transmission is expensive and therefore various techniques were proposed to allow multiple signals to be transmitted over a single fiber. The two most common techniques are Time Division Multiplexing (TDM) and Wavelength Division Multiplexing (WDM).

In TDM, separate input signals are carried on a single fiber by allocating time transmission windows. The input signals are fed to a multiplexer which schedules use of the optical fiber so that each input signal is allowed to use the fiber in a specific time slot. At the receiver, synchronization techniques are used to ensure that the different input signals are sent on to the appropriate destination.

In WDM, the fiber is shared by sending each input signal at the same time, but on a different carrier wavelength channel, for example a first signal could be transmitted using a carrier wavelength of 1539 nm and another signal is transmitted using a carrier signal of 1560 nm.

All modern optical data transmission utilizes TDM, with core transmission additionally utilizing WDM. In core data transmission, individual signals rates of up to 100 Gbit/sec are achieved through the use of TDM; these individual signals are then multiplexed onto a signal fiber through WDM in order to further enhance the transmission rate.

Considering WDM in greater detail, a grid of wavelengths is specified by the International Telecommunication Union (ITU) so that compliant equipment from different manufacturers can operate together. The ITU has specified a number of Dense Wavelength Division Multiplexing grid sizes at 12.5 Ghz, 25 Ghz, 50 Ghz and 100 Ghz 50 Ghz is currently the most popular channel and, using the DP-QPSK modulation format, it is possible to fit a 100 Gbit/s signal within a single channel in the 50 Ghz grid. However, research into optical transmission beyond 100 Gbit/s has shown that higher spectral efficiency formats have to be used, or the spectral width of the signals must be increased to support 400 Gbit/s or 1 Tbit/s transmission. Utilizing modulation formats with higher spectral efficiencies limits the distance the signal can propagate due to OSNR penalties, and increasing the spectral width means that the signal can no longer fit within the widely deployed 50 Ghz ITU grid. To overcome these problems, flexible grid or Flexgrid networks have been proposed. In this scheme, arbitrary sized wavelength blocks can be specified by the network owner, thereby accommodating new bit rate services.

In order to transmit signals by WDM, whether on the fixed grid or flexible grid network, two signals having different carrier wavelengths must be multiplexed onto the same line. Providing the carrier wavelengths are sufficiently different, the signals will not interfere with each other. At the end of the optical fiber, the incoming light signals are demultiplexed into the individual signals, which are subsequently processed as required.

Current telecommunications networks comprise a single optical fiber for data transmission in a given direction. The nodes at which these fibers meet are classified according to the number of fiber directions that converge at that node. For example, if optical fibers deliver data to and from North, South and West then the node at which these fibers meet is a degree three node. It will be appreciated that six fibers converge at a degree node if the network comprises a single fiber per direction: one fiber for data transmission from North, one fiber for data transmission to North, etc.

However, due to the ever increasing bandwidth demands on telecommunications networks, it is anticipated that multiple fibers per direction will be required in the near future. Accordingly, many more fibers will converge at a node of a given degree. For example, a degree three node in a “multi-fiber” network may comprise six or more fibers. In a multi-fiber arrangement such as this, it is envisaged that a number of independent channels or superchannels will be spread across the multiple fibers, the number of channels or superchannels carried on any one of the fibers being variable in accordance with the optical spectrum and/or the network architecture.

One known device for demultiplexing WDM signals is a grating demultiplexer, which operates on the principle of light dispersion: as an optical signal is passed through a grating demultiplexer, the various wavelengths contained within that signal are deflected by varying angles. The grating therefore acts to break down the optical signal into its constituent wavelength spectrum, which enables certain wavelength channels within that spectrum to be isolated and subsequently processed as required. Grating demultiplexers work moderately well with the fixed grid network, providing there are a low number of input fibers. However, there are likely to be problems associated with the use of grating demultiplexers in the flexible grid network and/or for large numbers of input fibers.

Existing equipment for fixed grid transmission is incompatible with Flexgrid, and therefore Flexgrid networks would require a new range of optical switching and transmission components. Development of new components and replacement across a network represents a significant cost commitment and implementation plan. It is not clear at this time whether it is most cost effective to invest in Flexgrid networks or to continue with networks based on the existing ITU grid. Another problem is lack of flexibility and the inability to interchange from one Flexgrid to fixed grid and vice versa if one grid scheme is chosen over the other.

### SUMMARY

Embodiments address the above issues. In one aspect, an embodiment provides an apparatus for routing an optical signal in an optical network, the signal configured to handle up to N independent wavelength channels, the apparatus comprising: at least three interface ports; an optical routing backplane coupled to the at least three interface ports at a backplane interface coupling portion; and optical pathways for connecting each interface port to at least two other interface ports via the optical backplane, wherein each backplane interface coupling portion comprises: a splitter receiver port for connecting a splitter for splitting said optical signal, first optical switch receiving means for receiving a first optical switch, second optical switch receiving means for receiving a second optical switch, and means for combining optical signals switched by at least one of said first or second switch so as to generate an output optical signal.

In use, optical signals comprising a plurality of independent wavelength channels may be received at one or more of the interface ports. The signals received at each input port may be routed to any one of the other interface ports. It is envisaged that the routing apparatus can be controlled to switch optical signals received at a given switch input port to an optical splitter comprising at least as many output ports as the number of independent wavelength channels received at the switch input port. In an embodiment, the apparatus for routing an optical signal further comprises a first optical switch and in an embodiment the first optical switch is configured to switch optical signals containing independent wavelength channels which have been placed in accordance with a fixed channel spacing. The fixed channel spacing is known as fixed grid transmission.

The apparatus for routing the optical signal may further comprise a second optical switch. The second optical switch in an embodiment may be configured to switch optical signals containing independent wavelength channels which have been placed in accordance with a variable channel spacing. The variable channel spacing is known as Flexgrid transmission and operation.

Routing apparatus has been developed wherein each input/output port has an optical splitter which splits the incoming signal so that both the fixed grid and the Flexgrid receive the input signal and can then switch the component wavelength signals to the appropriate output port. This relies on knowledge of the split and combining necessary being known at the outset of operation of the network and routing function so as to provide the correct components. Once in place the scheme is inflexible for future demands on the system and may be over specified as not all the input/output ports need to split the incoming signal, either due to one grid only be used or due to changing demand such that some nodes in the optical network are bypassed completely.

In an embodiment, the optical pathways are provided by an optical matrix switch. The first optical switch and the second optical switch may respectively comprise a first Wavelength Selective Switch (WSS) and a second Wavelength Selective Switch (WSS). The first Wavelength Selective Switch (WSS) may be configured to block different wavelength channels to at least another Wavelength Selective Switch.

In another aspect, an embodiment provides a method of reconfiguring an optical routing device having at least three interface ports and an optical routing backplane coupled to the at least three interface ports at a backplane interface coupling portion; each backplane interface coupling portion having a first optical switch and second optical switch receiving means for receiving a second optical switch, the method comprising: adding a second optical switch to at least one backplane interface coupling portion of the optical routing device. The method may include removing said first optical switch.

Embodiments locate the split function in the optical backplane and not at the external input/output ports. In this way the split and combine functionality can be made available in a flexible manner as and when it is required depending on network provision and traffic volume. The benefits include the speed of upgrade to Flexgrid from fixed grid and the ease of installation of fixed grid or Flexgrid WSSs and other components as required. A smooth introduction of new technology is provided without downtime and, until the new technology is installed, allows operation with fixed grid simultaneously. Remote installation is possible. In time, with increased availability of Flexgrid, the removal of a fixed grid component and switch from one port would allow the installation of a Flexgrid switch without prior knowledge of the new requirements and connection. In service upgrade to future systems and technologies (for example L band) is also envisaged.

Operational improvements to the existing optical matrix switch are possible and achieved as a 1×2 splitter does not need to be used at the outset and first operation of the network node. A backplane input is used to optionally switch to, or between, fixed and Flexgrid and be switched entirely to Flexgrid if available.

A related benefit is that fewer components are used so saving a few dB on the optical power budget of the system.

In a further aspect, an embodiment provides an optical network for carrying optical data signals, comprising at least one apparatus as herein described.

### BRIEF DESCRIPTION OF THE DRAWINGS

Embodiments will now be described with reference to the accompanying Figures in which:

FIG. 1 shows an overview of a data network in which one part of the network transports data signals optically.

FIG. 2 shows a more detailed view of the optical transmission network in which data signals are routed via optical routers.

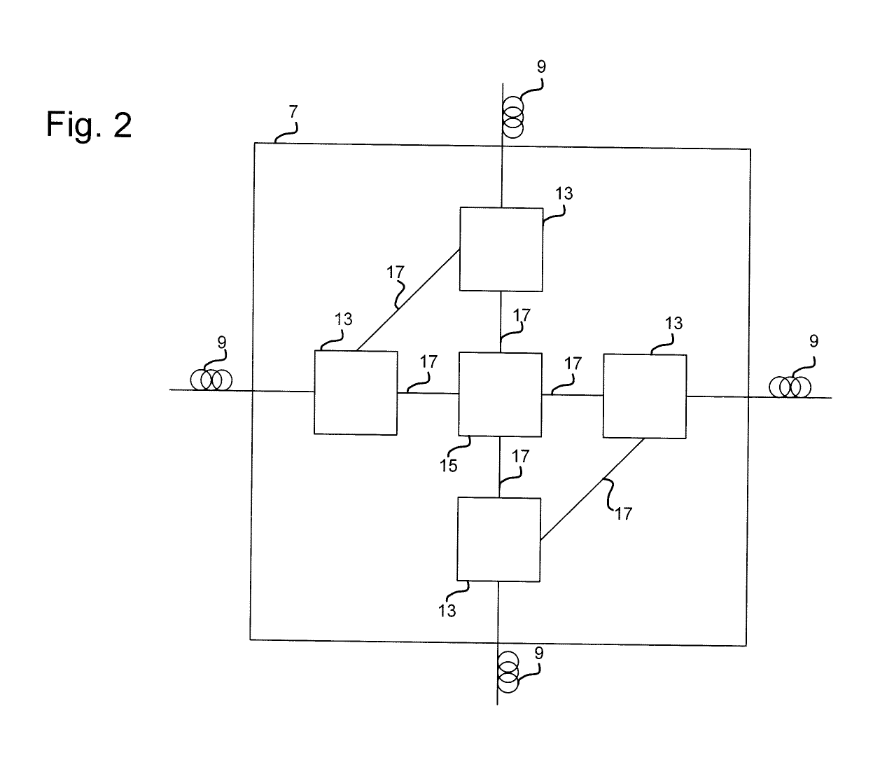

FIG. 3 shows the internal structure of an optical router illustrated in FIG. 2.

FIG. 4 shows the initial configuration the three port optical router containing fixed grid WSSs.

FIG. 5 shows the configuration of the three port optical router when some Flexgrid WSSs have been installed.

FIG. 6 shows the configuration of the three port optical router when fully converted to Flexgrid.

FIG. 7 shows the internal structure and configuration of an optical router in accordance with an embodiment.

FIG. 8 shows a flow diagram illustrating a method of routing optical signals in accordance with an embodiment.

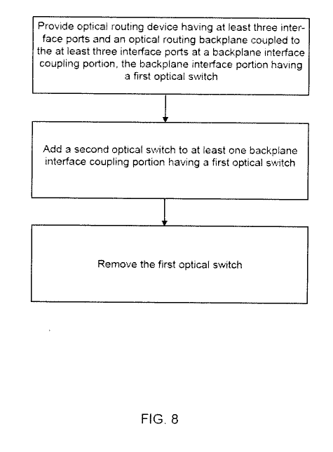

### DETAILED DESCRIPTION

### Definitions

As used herein, a “wavelength channel” is defined as a wavelength or a spectrum of wavelengths associated with a certain signal. It will be appreciated that the term includes, but is not limited to, a single optical carrier, typically a sine wave, with modulation. The term also includes so-called “superchannels,” in which multiple optical carriers (rather than a single optical carrier) are modulated and the combined group of modulated carriers are treated as a single channel.

As used herein, an “optical coupler” is defined as a device arranged to distribute optical signals received at one or more input ports to one or more output ports thereof. An M×N optical coupler comprises M input ports and N output ports. There are two primary types of optical coupler: optical splitters and optical combiners, both of which are defined below.

As used herein, an “optical splitter” is defined as a device arranged to receive optical signals at an input port thereof and output a copy of the received optical signals at each of multiple output ports thereof. A 1×N optical splitter comprises one input port and N output ports; optical signals received at the input port are branched to each of the N output ports (generally at a reduced power level compared to the signal received at the input port).

As used herein, the optical “backplane” of a node or network is a group of components in operable communication with each other and linked together such that they provide the backbone of a system to which other components may be connected to form a complete optical system. The backplane may be accessible and visible or may not be hidden from a user or operator.

The terms optical cross connect and optical matrix switch are used interchangeably and used to describe the switch.

As used herein, the “splitting capacity” of a splitter is defined as the number of output ports of that splitter. The “splitting capacity” of a cascade of splitters is defined as the number of output ports of the splitters within the cascade that are not connected to input ports of another splitter in the cascade. In other words, the “splitting capacity” is the number of “final” output signals that may be produced by a splitter or cascade of splitters.

As used herein, an “optical combiner” is defined as a device arranged to combine optical signals received at two or more input ports thereof and output the combined signal at an output port thereof. An M×1 optical combiner comprises M input ports and 1 output port; optical signals received at the M input ports are combined and the combined signals are output at the output port.

As used herein, an “optical waveblocker” is defined as a device arranged to block certain wavelengths within optical signals. An optical waveblocker may be arranged to block one or more wavelength channels within WDM optical signals.

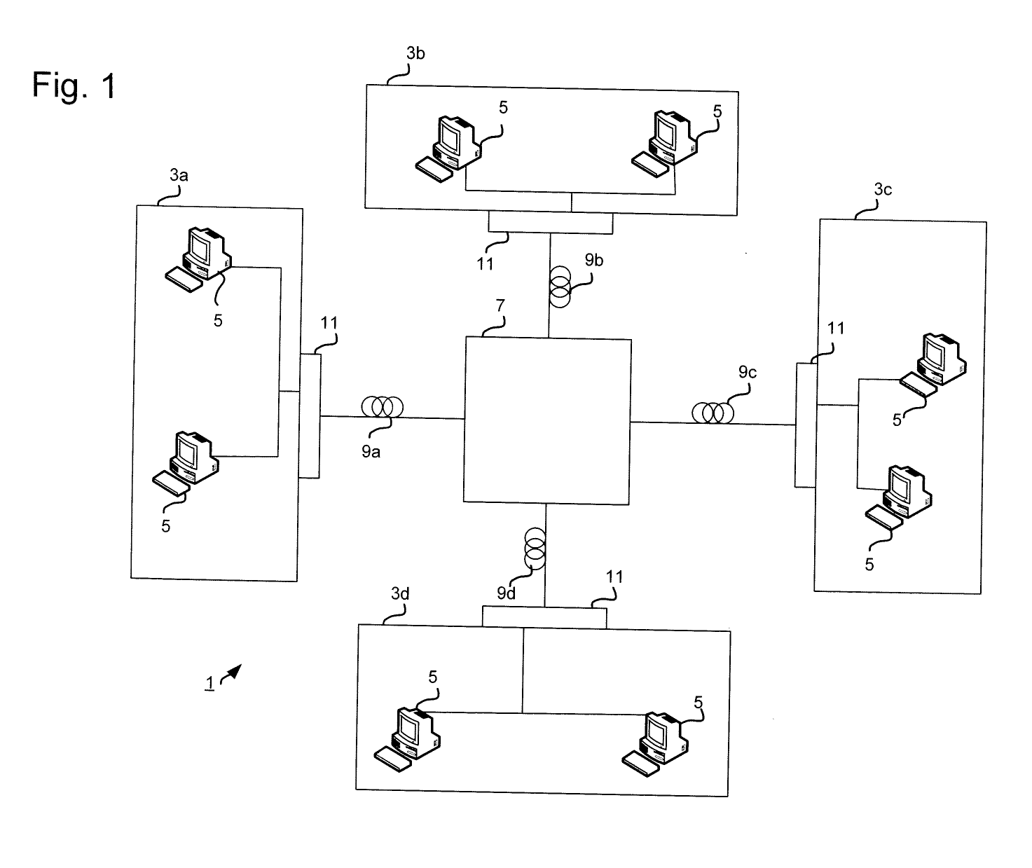

FIG. 1 shows an overview of a data network system 1 in which one part of the network 1 is configured to transport data signals using an optical signal.

In FIG. 1, four clusters of electrical signal data networks 3 are shown containing a number of network devices such as computers 5 which generate, send and receive data packets in the form of electrical data signals. The electrical networks 3 are connected to an optical backbone network 7 via bundles of optical fibers 9 so that the data can be routed between the different electrical networks optically. Each electrical network contains an optoelectronic converter 11 for converting electrical signals into optical signals and vice versa in a conventional manner.

FIG. 1 schematically illustrates a node 10 in a telecommunications network and the main components of the optical backbone network 7. Nodes such as that illustrated in the figure are known in the art. Due to the higher data capacity offered by optical fibers over copper cables, the optical network 7 has a much higher bandwidth and therefore is used to carry data between networks 3.

The optical network 7 is connected to the electrical data networks 3 via the bundles of optical fibers 9. The node in this embodiment comprises there are four sets of optical fiber bundles 9 carrying signals between the optical network 7 and four respective electrical data networks 3. Each of the four sets of optical fiber bundles 9 is associated with a different spatial location with respect to the node, thereby rendering the node a degree four node. The four spatial locations will henceforth be referred to as West, East, North and South for ease of reference.

The optical network 7 contains a number of optical routers 13, 15. For ease of explanation, in this embodiment, there are some optical routers 13 having three input/output ports whilst other optical routers 15 have four input/output ports. Interconnect optical fibers 17 link the three port and four port optical routers 13, 15.

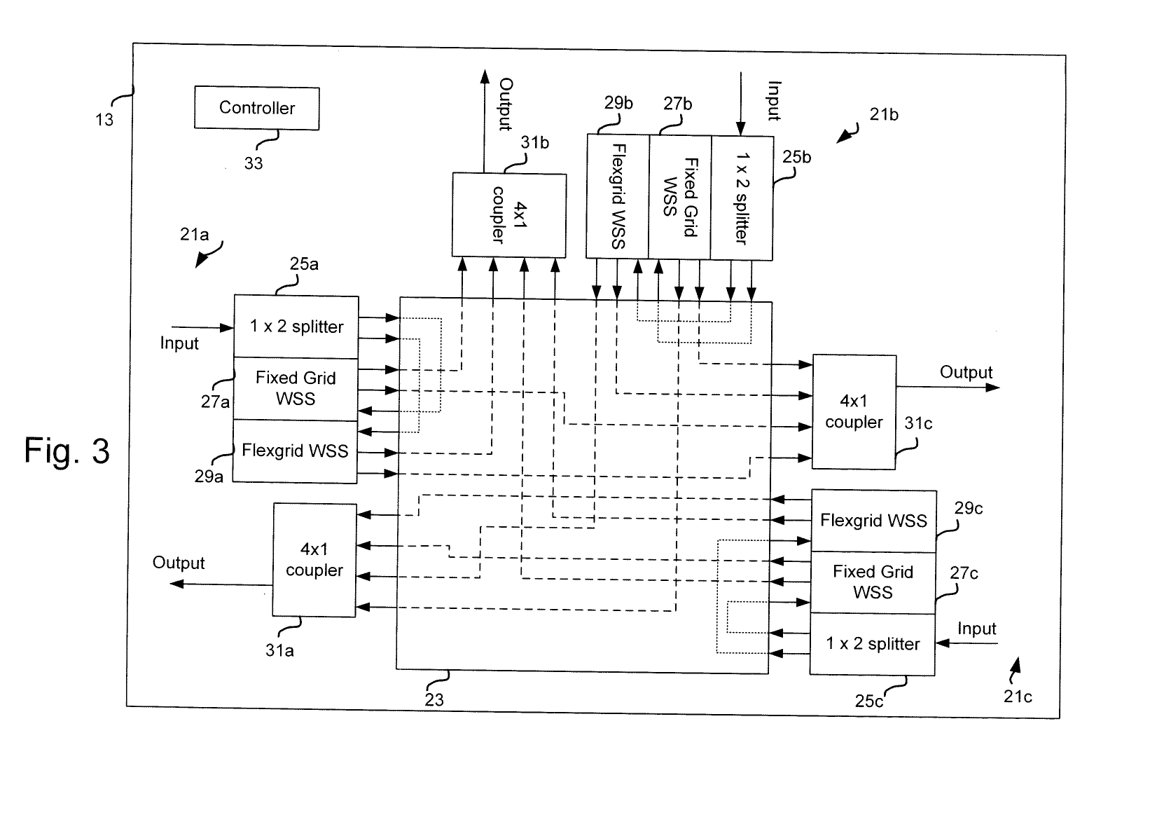

FIG. 3 shows a more detailed view of a three port optical router 13 of the prior art. Each set of optical fibers 9 is made up of two fibers: an input fiber for transporting optical signals towards the router 13 and an output fiber for transporting optical signals away from the router 13. This type of network is currently used across the telecommunications industry.

Each of the fibers in the set of optical fibers 9 is suitable for carrying Wavelength Division Multiplexed (WDM) optical signals, i.e. optical signals that comprise a plurality of independent wavelength channels.

In this router 13, there are three input/output ports 21 connected via an optical cross connect or optical matrix switch 23, and therefore optical signals entering via one port can leave the optical router 13 via one of two output ports. Input signals at port 21a can leave via port 21b or port 21c, input signals at port 21b can leave via port 21a or 21c and input signals at port 21c can leave via port 21a or 21b. The terms optical cross connect and optical matrix switch are used interchangeably herein and both used to describe the switch.

Whilst optical nodes and networks comprising a single fiber in each direction as illustrated in FIG. 3 are currently widely used, it is expected that a single fiber in each direction will not be sufficient to cope with the ever increasing bandwidth demands. Accordingly, it is anticipated that future optical nodes will have to cope with multiple optical fibers per direction, each optical fiber potentially carrying a plurality of independent wavelength channels.

Optical signals entering the optical router 13 on any of the input ports do not need to be converted into electrical signals in order to be routed to a destination port. The routing is performed in an optical manner on the basis of wavelength of the incoming optical signal and this is set by the optoelectronic converter 11 located at the interface between the electrical data network and the optical fiber bundles 9. The optical routers 13 contain Wavelength Selective Switches 27, 29 in order to perform the optical routing on the basis of the wavelengths of the input light signal.

In order to route both fixed grid and Flexgrid scheme transmissions, the optical router 13 can contain both fixed grid WSS 27 and Flexgrid WSSs 29. A fixed grid WSS 27 operates to route optical signals having 50 Ghz channel widths while a Flexgrid WSSs 29 routes optical signals having variable channel widths based on multiples of a channel width, for example, multiples of 12.5 Ghz or multiples of 25 Ghz.

Each input/output port 21 contains an optical splitter 25 which splits the incoming signal so that both the fixed grid WSS 27 and Flexgrid WSS 29 receive the input signal and can then switch the component wavelength signals to the appropriate output port via the optical cross connect 23. Each input/output port 21 also has an optical coupler 31 which combines redirected signals before outputting them onto via an optical fiber bundle 9 to a different downstream optical router 13 or to the edge of the optical network. Since the splitter reduces the power of the input optical signal, an optical amplifier may be located between the optical routers in order to regenerate the optical signals. Each input/output port 21 provides space to fit a fixed grid WSS 27 and a Flexgrid WSS 29 regardless of whether it is actually fitted. Therefore each input/output port 21 will be in one of three configurations:

fixed grid WSS 27 only;

fixed grid WSS 27 and Flex Grid WSS 29; or

Flex Grid WSS 29 only.

This allows flexibility on the configuration of the optical router 13 and in particular allows the optical routers 13 to be upgraded as Flexgrid WSSs 29 fall in price.

The configuration parameters for the WSS devices 27, 29 are controlled by a central controller 33.

An example of the operation of the existing art optical router 13 will now be described in the case that an input optical signal containing two signals, a 50 Ghz fixed grid based signal A and a 12.5 Ghz flex grid signal B, arrives at the optical splitter 25a of input/output port 21a. The optical splitter 25a splits the incoming signal into two identical but lower power signals onto the optical cross connect 23. The optical cross connect 23 is configured so that it provides light paths which connect the two outputs of the optical splitter 25a to the respective inputs of the fixed grid WSS 27a and the Flexgrid WSS 29a.

The fixed grid WSS 27a and the Flexgrid WSS 29a both receive the input signal via the splitter. The fixed grid WSS 27a is configured to block the Flexgrid signal B but direct the fixed grid signal A to an output port which could be port 21b or 21c. The fixed grid WSS therefore has two outputs which are connected via the optical cross connect 23 to optical coupler 31b of input/output port 21b and also optical coupler 31c of input/output port 21c. In the example, the fixed grid WSS is configured to direct signal A to the coupler 31b.

The Flexgrid WSS 29a is configured to block the fixed grid component signal A, but route Flexgrid signal B to either output of input/output port 21b or 21c. Flexgrid WSS 29a has two outputs onto the optical cross connect 23. One is directed to the optical coupler 31b and the other to the optical coupler 31c. In the example, the Flexgrid WSS is configured to direct signal B to the coupler 31b.

Each of the three fixed grid WSSs 27 has two outputs and each of the Flexgrid WSSs 29 has two outputs so therefore each optical coupler 31 has four inputs to receive each of the possible WSS outputs. In the example, signal A and signal B are received by the optical coupler 31b. The signals are coupled onto the same output optical fiber bundle 9 towards the next optical router 13 or destination network.

In the above description, the optical router 13 has the ability to contain both fixed grid and Flexgrid WSSs 27, 29. However, Flexgrid technology is still at a fairly early stage and therefore it is not expected that the optical routers 13 would be deployed in the configuration as shown in FIG. 3.

The configuration of the optical routers 13 with groups of input/output ports 21 each having an optical splitter 25 and an optical coupler 31 allows the optical router 13 to be incrementally upgraded as Flexgrid WSSs mature.

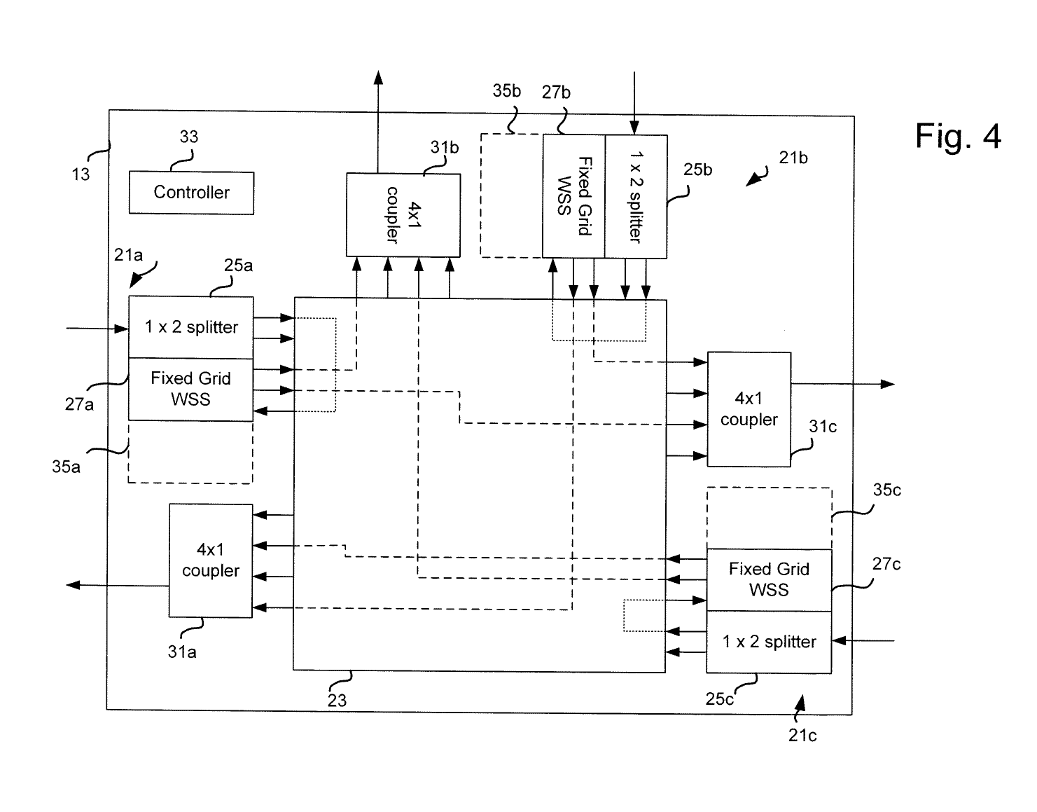

FIG. 4 shows an initial configuration for the optical router 13 in which received optical signals conform to the fixed grid scheme and therefore the optical routers contain conventional fixed grid WSS devices 25 to optically route the optical signals. In this configuration, the controller 31 sets the splitter 25 to redirect all incoming light signals to the installed fixed grid WSS 27. Any fixed grid signals are routed to one of the couplers 29 of the other two ports 21. The ports contain a space 35 for the Flexgrid WSSs which will eventually be installed.

At a later point in time, when it is expected that Flexgrid has matured enough that Flexgrid WSS devices are available, the optoelectronic converters 11 are upgraded to support Flexgrid and therefore it is necessary to upgrade the core optical network 7 to support Flexgrid.

Installing an entire new Flexgrid enabled core network would be expensive and time intensive due to the equipment and installation costs. The configuration of the optical routers 13, however, allows the optical network to be upgraded incrementally with Flexgrid WSS 27 devices and the optical router 13 can switch to using Flexgrid without significant changes.

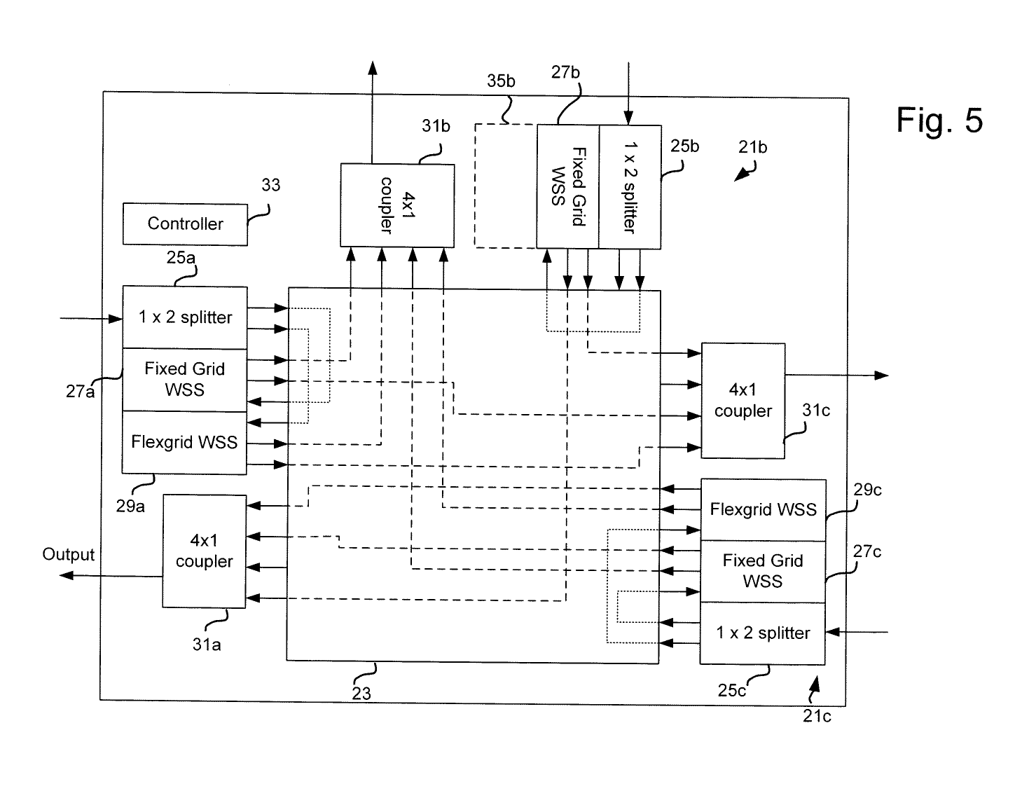

FIG. 5 shows the optical router 13 with two of the input/output ports 21a and 21c upgraded with Flexgrid WSSs 29 while the third input/output port 21b has not been upgraded yet.

With the partial upgrade, cost savings can be made while improving the functionality of the optical router 13. In this partial upgrade configuration, the optical router 13 is able to carry both Flexgrid and fixed grid optical signals between ports 21a and 21c while fixed grid signals can be routed between ports 21a,21b and 21c. Therefore the optical router 13 has been improved without carrying out a full upgrade.

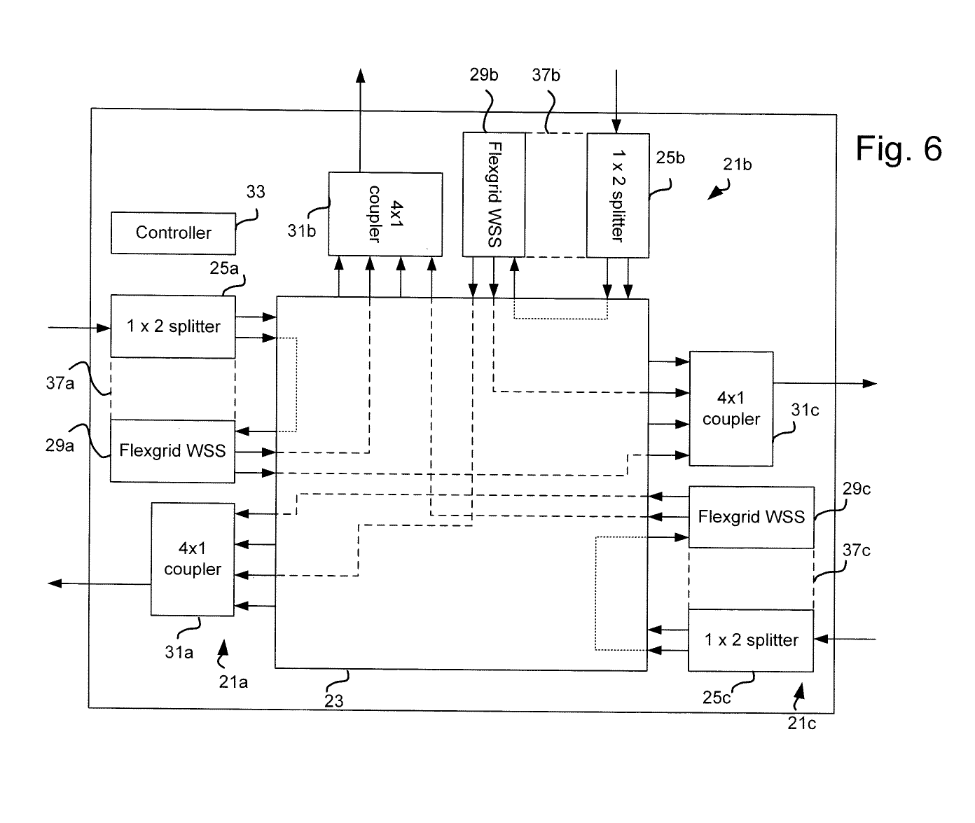

FIG. 6 shows a later configuration in which the optical router 13 is switched entirely to Flexgrid operation. In this case the fixed grid WSSs 25 are not present in the optical router 13 and only Flexgrid WSSs 27 are used to route the optical signals based on wavelength. Each splitter 25 splits the incoming optical signals to two signals on the optical cross connect 23 but since only the Flexgrid WSSs 29 are connected, the signals which would previously have entered the fixed grid WSS are blocked and the component parts of input signals entering the FlexGrid WSS 29 are switched to an appropriate output port according to wavelength.

The space 37 within the optical router 131eft by the removal of the fixed grid WSS 25 can be reutilized. For example, if industry moves beyond the capabilities of the Flexgrid scheme, then new switches based on wavelength switching or other technology can be replaced into the optical router 13. An example could be switches which operate in the L frequency band (390 Mhz to 1.55 Ghz).

For ease of explanation, the operation of a three input/output port optical router 13 has been described. However, typically the optical routers would have more ports and therefore the number of inputs that the optical couplers can potentially combine and the number of optical paths provided within the optical cross connect are higher.

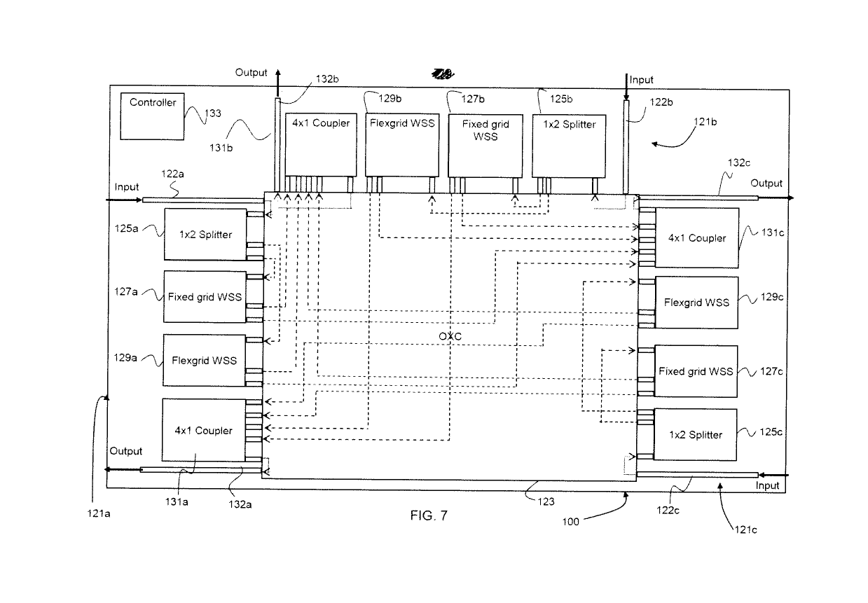

FIG. 7 shows a more detailed view of a three port optical router 100. In this router 100, there are three input/output ports 121 connected via an optical cross connect 123 and therefore optical signals entering via one port can leave the optical router 100 via one of two output ports. Input signals at port 121a can leave via port 121b or port 121c, input signals at port 121b can leave via port 121a or 121c and input signals at port 121c can leave via port1 121a or 121b.

Each input/output port 121 contains an optical cross connect input port 122. Optical signals from input optical fibers (not shown) enter the router 100 via the optical cross connect input ports 122.

Each input/output port 121 also contains an optical cross connect output port 132. Optical signals switched to the optical cross connect output ports 132 are output via output optical fibers to a different downstream optical router or to the edge of the optical network.

Each input/output port 121 contains a space for a 1×2 optical splitter 125. The splitter 125 comprises an input port arranged to receive optical signals and two output ports arranged to output identical copies of the optical signals received at the input port. The optical splitter 125 may be detachably coupled to the optical cross connect 123, the input and output ports of the optical splitter 125 defining respective ports of the optical cross connect 123 when the optical splitter 125 is coupled thereto.

Each input/output port 121 contains spaces for fixed grid and Flexgrid Wavelength Selective Switches (WSSs) 127, 129 in order to provide capability to route both fixed grid and Flexgrid scheme transmissions. The WSSs 127, 129 may be detachably coupled to the optical cross connect 123, the input and output ports of the WSSs 127, 129 defining respective ports of the optical cross connect 123 when the WSSs 127, 129 are coupled thereto. The fixed grid WSS 127 may be coupled separately to the Flexgrid WSS 129. The WSSs 127, 129 are configured to perform the optical routing on the basis of the wavelengths of the input light signal. A fixed grid WSS 127 operates to route optical signals having 50 Ghz channel widths while a Flexgrid WSSs 129 routes optical signals having variable channel widths based on, for example, multiples of 12.5 Ghz. The configuration parameters for the WSS devices 27, 29 are controlled by a central controller 133.

Each input/output port 21 also contains space for a 4×1 optical coupler 131 which combines redirected signals from other input/output ports 121. The 4×1 optical coupler 131 may be detachably coupled to the optical cross connect 123, the input and output ports of the optical coupler 131 defining respective ports of the optical cross connect 123 when the optical coupler 131 is coupled thereto.

The optical cross connect input port 122 and the optical cross connect output port 132 define an input/output plane of the respective input/output port 121. All of the additional connections within the optical cross connect are located in the backplane. It will be appreciated that the backplane is located “beneath” the input/output plane, i.e. optical signals must cross the input/output plane prior to being switched to any of the splitters 125, couplers, 131 or WSSs 127, 129 connected to the optical cross-connect. It is envisaged that the backplane will be hidden and function out of sight to a user but this is not essential.

An example of the operation of the optical router 100 when in the configuration illustrated in FIG. 7 will now be described in the case that an input optical signal containing two signals, a 50 Ghz fixed grid based signal A and a 12.5 Ghz flex grid signal B, arrives at the optical cross connect 123 via the optical cross connect input port 122a of the input/output port 121a. The signals are switched to the input of the optical splitter 125a via the optical cross connect 123. The optical splitter 125a splits the incoming signal into two identical but lower power signals onto the optical cross connect 123. The optical cross connect 123 is configured so that it provides light paths which connect the two outputs of the optical splitter 125a to the respective inputs of the fixed grid WSS 127a and the Flexgrid WSS 129a.

The fixed grid WSS 127a and the Flexgrid WSS 129a both receive the input signal via the splitter 125a. The fixed grid WSS 127a is configured to block the Flexgrid signal B but direct the fixed grid signal A to an output port which could be port 121b or 121c. The fixed grid WSS 127a therefore has two outputs which are connected via the optical cross connect 123 to optical coupler 131b of input/output port 121b and also optical coupler 131c of input/output port 121c. In the example, the fixed grid WSS is configured to direct signal A to the coupler 131b.

The Flexgrid WSS 129a is configured to block the fixed grid component signal A, but route Flexgrid signal B to either output of input/output port 121b or 121c. Flexgrid WSS 129a has two outputs onto the optical cross connect 123. One is directed to the optical coupler 131b and the other to the optical coupler 131c. In the example, the Flexgrid WSS is configured to direct signal B to the coupler 131b.

Each of the three fixed grid WSSs 127 has two outputs and each of the Flexgrid WSSs 129 has two outputs so therefore each optical coupler 131 has four inputs to receive each of the possible WSS outputs. In the example, signal A and signal B are received by the optical coupler 131b. The signals are coupled and output to the optical cross connect output port 132 via the optical cross connect 123.

FIG. 7 illustrates a configuration in which the router 100 provides both fixed grid and Flexgrid compatibility, i.e. the router comprises both fixed grid and Flexgrid WSSs 127, 129 and optical signals received from the input optical fibers may be switched to either WSS. However, Flexgrid technology is still fairly premature and therefore it is not expected that the optical routers 100 would be deployed in the configuration as shown in FIG. 3. Rather, it is envisaged that the 1×2 optical splitters 125 and the Flexgrid WSSs 129 will be omitted from the router 100 until it is desired to at least partially upgrade the router to Flexgrid. In addition, the 4×1 optical couplers 131 may be omitted and 2×1 optical couplers (not shown) provided in their place, the coupler inputs being arranged to receive optical signals from the fixed grid WSSs 127 of the other input/output ports 121.

At a later point in time, when it is expected that Flexgrid has matured enough that Flexgrid WSS devices are widely available and broadly accepted, network operators may wish to upgrade the core optical network to support Flexgrid. Installing an entire new Flexgrid enabled core network would be expensive and time intensive due to the equipment and installation costs. The configuration of the optical routers 100, however, allows the optical network to be upgraded incrementally with Flexgrid WSS 127 devices and the optical router 100 can switch to using Flexgrid without significant changes. Furthermore, the upgrade of the router 100 to Flexgrid may be implemented in stages. For example, two of the input/output ports 121a and 121c may be upgraded with Flexgrid WSSs 29 whilst upgrade of the third input/output port 121b may be delayed until a later date. In this partial upgrade configuration, the optical router 100 is able to carry both Flexgrid and fixed grid optical signals between ports 121a and 121c while fixed grid signals can be routed between ports 121a, 121b and 121c. Therefore the optical router 100 has been improved without carrying out a full upgrade. With the partial upgrade, cost savings can be made while improving the functionality of the optical router 100.

Considering the upgrade process in more detail, once it is desired to upgrade a given input input/output port 121 to have both fixed grid and Flexgrid compatibility, it is envisaged that a user will couple the optical splitter 125 to the optical cross connect 123 such that the input and output ports of the optical splitter 125 define ports of the optical cross connect 123. The user will also couple the Flexgrid WSS 129 to the optical cross connect 123 such that the input and output ports of the Flexgrid WSS 129 define ports of the optical cross connect 123. The optical cross connect 123 will be controlled to switch optical signals arriving at the optical cross connect input port 122 to the input port of the optical splitter 125. The optical splitter 125 will thus produce two identical copies of the optical signals received at the optical cross connect input port 122, one of which will be switched to the fixed grid WSS 127 via the optical cross connect 123 and one of which will be switched to the Flexgrid WSS 129 via the optical cross connect 123. It is envisaged that the user will also replace the 2×1 optical coupler (not shown) with the 4×1 optical coupler 131. The optical cross connect 123 will be controlled such that the 4×1 optical coupler 131 receives optical signals from the Flexgrid WSSs 129 of the adjacent input/output ports 121 in addition to optical signals from the fixed grid WSSs 127 of the other input/output ports 121.

In use, optical signals received at the optical cross connect input port 122 will be switched, via the optical splitter 125, to both the fixed grid WSS 127 and the Flexgrid WSS 129. The fixed grid WSS 127 and Flexgrid WSS 129 may then switch the component wavelength signals to the appropriate output port via the optical cross connect 123. In addition, optical signals from both the fixed grid WSSs 217 and Flexgrid WSSs 129 of other input/output ports 121 may be combined at the 4×1 optical coupler 131 and subsequently output to output optical fibres (not shown).

Once it is appropriate to switch the router 100 to operate on Flexgrid only, it is envisaged that a user will de-couple the optical splitter 125 and the fixed grid WSS 127 from the optical cross connect 123. The use may also replace the 4×1 optical coupler 131 with a 2×1 optical coupler. The optical cross connect 123 will be controlled to switch optical signals arriving at the optical cross connect input port 122 to the Flexgrid WSS 129. Upon receiving the optical signals, the Flexgrid WSS 129 will switch the component wavelength signals to the appropriate output port via the optical cross connect 123.

It will be appreciated that coupling the optical splitter 125 and optical coupler 131 to the backplane facilitates the addition or removal of these components according to the demand therefor. A major advantage of removing components from the optical cross connect 123 when they are no longer required is that optical cross connect ports are made available, which may be utilized for other purposes.

### Alternatives and Modifications

Using optical cross connects is advantageous because it allows for fast remote provisioning of Flexgrid and allows the fixed grid WSS to be freed and reused elsewhere. However, in an alternative configuration the optical cross connect is replaced with permanent light paths between the inputs and outputs of the optical router. Such a configuration provides a cheaper optical router while still providing the ability to upgrade to Flexgrid WSSs.

1. Apparatus for routing an optical signal in an optical network, the signal configured to handle up to N independent wavelength channels, the apparatus comprising:
at least three interface ports;
an optical routing backplane coupled to the at least three interface ports at a backplane interface coupling portion; and
optical pathways for connecting each interface port to at least two other interface ports via the optical backplane,
wherein each backplane interface coupling portion comprises:
a splitter receiver port for connecting a splitter for splitting said optical signal,
first optical switch receiving means for receiving a first optical switch,
second optical switch receiving means for receiving a second optical switch, and
means for combining optical signals switched by at least one of said first or second switch so as to generate an output optical signal.

2. Apparatus according to claim 1, further comprising a first optical switch.

3. Apparatus according to claim 2 wherein said first optical switch is configured to switch optical signals containing independent wavelength channels which have been placed in accordance with a fixed channel spacing.

4. Apparatus according to claim 2, further comprising a second optical switch.

5. Apparatus according to claim 4 wherein said second optical switch is configured to switch optical signals containing independent wavelength channels which have been placed in accordance with a variable channel spacing.

6. Apparatus according to claim 1, wherein the optical pathways are provided by an optical matrix switch.

7. An apparatus according to claim 5, wherein the first optical switch and the second optical switch respectively comprise a first Wavelength Selective Switch (WSS) and a second Wavelength Selective Switch (WSS).

8. An Apparatus according to claim 7, wherein the first Wavelength Selective Switch (WSS) is configured to block different wavelength channels than at least another Wavelength Selective Switch.

9. A method of reconfiguring an optical routing device having at least three interface ports and an optical routing backplane coupled to the at least three interface ports at a backplane interface coupling portion, each backplane interface coupling portion having a first optical switch and second optical switch receiving means for receiving a second optical switch, the method comprising:
adding a second optical switch to at least one backplane interface coupling portion of the optical routing device.

10. A method according to claim 9, further comprising removing said first optical switch.

11. An optical network for carrying optical data signals, comprising at least one apparatus according to claim 1.
